(19) United States
(12) Patent Application Publication
(10) Pub. No.: US 2013/0077831 A1
(43) Pub. Date: Mar. 28, 2013

(54) MOTION RECOGNITION APPARATUS, MOTION RECOGNITION METHOD, OPERATION APPARATUS, ELECTRONIC APPARATUS, AND PROGRAM

(71) Applicants: Taku MOMOZONO, Kanagawa (JP); Kota YONEZAWA, Kanagawa (JP)

(72) Inventors: Taku MOMOZONO, Kanagawa (JP); Kota YONEZAWA, Kanagawa (JP)

(73) Assignee: Sony Corporation, Tokyo (JP)

(21) Appl. No.: 13/590,657

(22) Filed: Aug. 21, 2012

(30) Foreign Application Priority Data
Sep. 26, 2011 (JP) 2011-208947

(51) Int. Cl. G06K 9/62

(52) U.S. Cl. 382/107

(57) ABSTRACT

The present disclosure provides a motion recognition technique which simplifies computing processes and which can be implemented without recourse to a large amount of computing resources, as well as a technique for controlling a control target apparatus by use of the same motion recognition technique. A motion recognition apparatus is disclosed which includes a motion recognition part configured such that upon recognizing a recognition target object moving from one determination area to one other determination area before moving back to that one determination area, the motion recognition part recognizes a predetermined swing motion.

### BACKGROUND

The present disclosure relates to a motion recognition apparatus, a motion recognition method, an operation apparatus, an electronic apparatus, and a program. More particularly, the disclosure relates to a technology for recognizing the motion (motion recognition technology) of a recognition target object (test object) such an operator's hand or head, the technology being applied to an operation apparatus (instruction input apparatus) for controlling a control target apparatus based on the result of the recognition as well as to an interface apparatus, for example.

Some techniques for recognizing the motion of a human (e.g., entire body, head, hand, fingertips) and using the result of the recognition to operate an electronic apparatus such as TV sets, audio equipment and computers (control target apparatus) are proposed today (as operation techniques utilizing gesture recognition).

For example, interface apparatuses have been proposed for display control under which the shape and motion of an operator's hand are recognized from an image taken to include the operator by a CCD camera incorporated in a display unit, and the shape and position of an instruction icon displayed on the screen are changed based on the result of the recognition so that instructions may be issued by hand gestures. In this case, the operator needs to memorize the hand gestures used to issue the instructions. The effort of such memorization can be a burden on the operator in giving the instructions.

In this respect, Japanese Patent Laid-Open No. 2008-52590 (called Patent Literature 1 hereunder) proposes an interface apparatus that recognizes the hand gestures performed by an operator so that the operator may operate a control target apparatus more reliably based on the recognized hand gestures. According to the disclosed technique, a gesture recognition part takes an image including the operator's hand, recognizes one or more hand shapes or hand gestures as a recognition target from an input image and, based on instruction information corresponding to the recognized hand shape or hand gesture, controls the target apparatus while causing a gesture information display part to display a normative image of the recognizable hand shape or hand gesture. For example, the gesture information display part may display a list of gestures to be used for operations, the result of the recognition by the gesture recognition part, and an image of what may be considered the operator's hand in part. The operator is allowed to perform operations while verifying the screen, with no need to memorize gestures. It is thus possible to modify the gestures performed by the operator so that the gesture recognition part may recognize the gestures more easily, which improves the ease of operation. The technique allows the operator to perform operations without having to memorize the hand shapes or hand gestures for operating the interface apparatus.

Meanwhile, Japanese Patent Laid-Open No. Hei 10-113343 (called Patent Literature 2 hereunder) proposes a recognition apparatus that automatically recognizes the motions and behavior of mobile objects such as humans, animals or machines. According to the disclosed technique, a measurement section is attached to a test object to observe changes in the state of the motion or behavior of the test object. A feature quantity extraction section extracts the feature quantity based on the result of the observation. Furthermore, a storage section is provided to store beforehand the feature quantities of the motions or behavior to be recognized by the recognition apparatus. The motion or behavior of the test object is recognized based on the feature quantities extracted from the result of the observation and on the feature quantities held in the storage section, and the result of the recognition is output. For example, measuring instruments are attached to a human subject to measure changes in the state of the human subject's motion or behavior. A feature quantity extraction part is used to extract from measurement signals the feature quantities of the motion or behavior currently performed by the human subject. A signal processing apparatus for motion or behavior recognition determines correlations between the extracted feature quantities and the reference data included in a database that contains the previously stored feature quantities of motions or behavior. The signal processing apparatus outputs the motion or behavior signified by the most highly correlated feature quantity as the result of the recognition. According to this technique, the changes in the state of the human subject or test object are measured but the result of the measurement is not used simply as measured values. Instead, the feature quantities of the measured state changes are subjected to automatic recognition processing, allowing the human subject's motion or behavior to be recognized more accurately than before.

### SUMMARY

Conceivable techniques for recognizing the operator's motions (e.g., hand gestures) include those described in Patent Literatures 1 and 2 and others for recognizing the shape of the recognition target object (e.g., hand). However, some recognition target objects have complicated shapes (e.g., in the case of the hand) and are difficult to recognize. The technique disclosed in Patent Literature 2 proposes recognition through learning. In this case, large quantities of computing resources are needed including a high-speed CPU (Central Processing Unit) and mass memory. It is difficult to recognize the object of a varying shape such as the human hand. Implementing this type of recognition involves large quantities of learning data as well as complicated, time-consuming learning processes. Also, a large quantity of memory space is needed to accommodate the data resulting from learning processes.

The present disclosure has been made in view of the above circumstances and provides a motion recognition technique which simplifies computing processes and which can be implemented without recourse to a large amount of computing resources, as well as a technique for controlling a control target apparatus by use of the same motion recognition technique.

According to one embodiment of the present disclosure, there is provided a motion recognition apparatus including a motion recognition part configured such that upon recognizing a recognition target object moving from one determination area to one other determination area before moving back to that one determination area, the motion recognition part recognizes a predetermined swing motion. Preferably, the motion recognition apparatus of this embodiment may be implemented in variations offering further benefits.

According to another embodiment of the present disclosure, there is provided a motion recognition method including recognizing a recognition target object moving from one determination area to one other determination area before moving back to that one determination area; and using the result of the recognition in controlling a control target apparatus.

According to a further embodiment of the present disclosure, there is provided an operation apparatus including a motion recognition part configured such that upon recognizing a recognition target object moving from one determination area to one other determination area before moving back to that one determination area, the motion recognition part recognizes a predetermined swing motion; and a control part configured to control a control target apparatus based on the result of the recognition by the motion recognition part.

According to an even further embodiment of the present disclosure, there is provided an electronic apparatus including a processing part configured to perform processes corresponding to apparatus functions; a motion recognition part configured such that upon recognizing a recognition target object moving from one determination area to one other determination area before moving back to that one determination area, the motion recognition part recognizes a predetermined swing motion; and a control part configured to control the processing part based on the result of the recognition by the motion recognition part.

The technology of the present disclosure may also be implemented using a computer running on software. It is possible to extract such a program and a recording medium on which the program is stored as further embodiments of the present disclosure. For example, a program provided as another embodiment of this disclosure may cause a computer to function as an apparatus including a motion recognition part configured such that upon recognizing a recognition target object moving from one determination area to one other determination area before moving back to that one determination area, the motion recognition part recognizes a predetermined swing motion; and a control part configured to control a control target apparatus based on the result of the recognition by the motion recognition part. The program may be offered stored on a computer-readable recording medium or distributed via a wired or wireless communication section.

Preferably, the motion recognition method, operation apparatus, electronic apparatus, and program of the above-outlined embodiments may each be implemented in variations which offer further benefits and which are comparable to the variations of the motion recognition apparatus embodying the disclosure.

In short, the technology disclosed in this specification involves recognizing the recognition target object moving from one determination area to one other determination area before moving back to that one determination area, and controlling the control target apparatus or the processing part of a control target based on the result of the recognition. A predetermined swing motion is recognized if the recognition target object is recognized to move from one position to one other position before moving back to that one position. To recognize such predetermined swing motions involves merely recognizing rough movement status of the recognition target object. The presence or absence of a swing motion can be recognized in a relatively easy manner; there is no need for shape recognition that would involve complicated computing processes or for a learning method that would require a large amount of computing resources.

Where the motion recognition apparatus, motion recognition method, operation apparatus, electronic apparatus, or program embodying the present disclosure is in use, it is possible to bring about a motion recognition technique which can simplify computing process and be implemented without recourse to massive computing resources and to implement a technique for controlling the control target apparatus using the disclosed motion recognition technique.

### BRIEF DESCRIPTION OF THE DRAWINGS

FIGS. 1A and 1B are explanatory views explaining a first embodiment of the present disclosure;

FIG. 2 is an explanatory view explaining typical flip gestures;

FIG. 3 is an explanatory view explaining typical areas for use in recognizing directions;

FIG. 4 is a state transition diagram in effect when a motion recognition apparatus recognizes directions;

FIG. 5 is a flowchart explaining a procedure performed by a motion recognition part;

FIGS. 6A and 6B are explanatory views explaining examples of control performed by an operation control part of the first embodiment;

FIGS. 7A, 7B and 7C are explanatory views explaining how a finalize instruction, a back instruction, and an end instruction for menu operations are typically identified with flip motions;

FIGS. 8A and 8B are explanatory views explaining a second embodiment of the present disclosure;

FIGS. 9A, 9B and 9C are explanatory views explaining how a finalize instruction, a back instruction, and an end instruction for menu operations with the second embodiment are typically identified with flip motions;

FIGS. 10A and 10B are explanatory views explaining a third embodiment of the present disclosure; and

FIGS. 11A and 11B are explanatory views explaining a fourth embodiment of the present disclosure.

### DETAILED DESCRIPTION OF THE PREFERRED EMBODIMENTS

Some preferred embodiments of the present disclosure will now be described in detail by reference to the accompanying drawings. In the ensuing description and throughout the accompanying drawings, the functional elements of the disclosed technology will be designated by reference numerals that may each be suffixed with an alphabetical character identifying a specific embodiment where the embodiments are distinguished from one another. Where such distinction is not necessary, these alphabetical characters for reference purposes will be omitted.

The description will be given under the following headings:

1. Overview, and

2. Specific application examples including:
First embodiment by which the recognition target object in two-dimensional motion is recognized;
Second embodiment by which the recognition target object in three-dimensional motion is recognized;
Third embodiment by which a plurality of electronic apparatuses are controlled using a network; and
Fourth embodiment by which a plurality of electronic apparatuses are controlled using a learning remote controller.

### <Overview>

The fundamental matters of the disclosed technology are explained first. With the motion recognition apparatus, motion recognition method, operation apparatus, electronic apparatus, and program disclosed in this specification, upon recognizing a recognition target object moving from one determination area to one other determination area before moving back to that one determination area, a motion recognition part recognizes a predetermined swing motion. A control part controls a control target apparatus or the processing part of a control target based on the result of the recognition by the motion recognition part.

For example, if the recognition target object is a human hand, it is possible to recognize the moving status of the hand (hand gesture) constituting the recognition target object using solely the center (of gravity) coordinates of the hand, which is information acquired with relative ease for example. The shape of the hand is not used to recognize only the direction designated by the operator. Instead, the swing motion of the hand is recognized to perform a movement in as many as N steps in the direction designated by the operator. This kind of technique is useful in performing GUI (Graphical User Interface) menu selection operations for example.

For example, upon recognizing the recognition target object moving from an origin determination area to one determination area before moving back to the origin determination area without passing through any other determination area, the motion recognition part recognizes a swing motion indicative of the direction in which that one determination area exists relative to the origin determination area. More specifically, the motion recognition part recognizes a swing motion indicative of a direction if determination areas are defined in a plurality of directions in reference to the origin determination area with distances to the latter exceeding a threshold value each and if the recognition target object is recognized to move from the origin determination area to one determination area before moving back to the origin determination area without passing through any other determination area. In this manner, the presence or absence of one flip operation indicative of a direction is recognized.

Alternatively, in recognizing anything other than one flip operation indicative of a direction (e.g., finalize, back, or end operation), the motion recognition part may recognize the recognition target object moving sequentially through a plurality of determination areas. In that case, the motion recognition part recognizes a predetermined swing motion which differs from the swing motion indicative of any direction and which corresponds to the sequence of the object movement.

The presence or absence of one flip operation indicative of a direction, as well as the presence or absence of an operation other than that type of flip operation, may be recognized based on the moved state of the recognition target object recognized using solely the point of interest (e.g., center coordinates) of the object, which is information obtainable with relative ease. The result of the recognition is used to determine whether a predetermined swing motion is performed. The control part instructs the control target apparatus to perform a predetermined operation corresponding to the swing motion recognized by the motion recognition part.

Incidentally, the recognition target object may not always move in the expected sequence. In such a case, if the recognition target object moves from the origin determination area to one determination area and then passing through an unexpected area before moving back to the origin determination area, for example, the motion recognition part may recognize an inter-area movement nullified state. Furthermore, if the recognition target object is recognized to move back to the origin determination area following the recognition of the inter-area movement nullified state, the motion recognition part may cancel the inter-area movement nullified state at this point.

Also, the recognition target object may not always start from the same origin determination area. In such a case, upon recognizing the recognition target object moving from the origin determination area to one other area and staying in the other area for at least a predetermined time period, the motion recognition part may set the other area as a new origin determination area.

When the recognition target object is moved, the boundary between the areas may be recognized not as definitive but as fluctuating. If the fluctuating boundaries are recognized as they are, it is difficult to recognize the recognition target object moving in the expected sequence. To counter this bottleneck, a buffer boundary not recognizable as any area may be provided between the determination areas.

There are diverse basic techniques available (i.e., sensing section) for recognizing the recognition target object. Various sensors (velocity and acceleration sensors, flexion angle sensors, etc.) may be used to detect the recognition target object (e.g., operator's hand) in motion. There also exist recognition techniques utilizing diverse sensors including ultrasonic and pressure sensor arrays, microphones (for voice recognition), and human sensors (pyroelectric sensors) for example. It is also possible to use depth map sensors, thermography, or an image sensing technique. The image sensing technique may be used in combination with markers for the ease of recognition. In any case, rough movements of the recognition target object need only be recognized; there is no need for detailed computing processes such as shape analysis. Where the image sensing technique is applied, an image pickup apparatus is provided to take images of the recognition target object. The motion recognition part performs the process of recognizing the recognition target object in motion based on the image taken of the latter by the image pickup apparatus.

Also when the image sensing technique is applied, the recognition of the recognition target object is not limited to its two-dimensional motion. If stereoscopic images are used, it is further possible to recognize the recognition target object in three-dimensional motion. That is, the motion recognition part performs the process of recognizing the recognition target object in three-dimensional motion based on a stereoscopic image taken of the latter. Stereoscopic images may be acquired using either a plurality of monocular cameras or a stereoscopic (binocular) camera. It should be noted that if multiple monocular cameras are set up with a long distance interposed therebetween, recognition error in the image taken thereby is bound to increase. Thus the image pickup apparatus may preferably be a binocular (stereoscopic) camera capable of taking stereoscopic images of the object.

When the operator gives operating instructions by moving his or her hand, for example, the operator may not give the instructions smoothly without knowledge of what is being recognized by the motion recognition apparatus. To counter this potential bottleneck, the motion recognition apparatus, motion recognition method, operation apparatus, electronic apparatus, or program disclosed in this specification should preferably be provided with a notification part giving notification of the state being recognized by the motion recognition part or of the state of the control target apparatus being controlled by the control part.

For the operation apparatus or program disclosed in this specification, there may exist more than one electronic apparatus (i.e., control target apparatus). That is, the control part may be configured to control a plurality of control target apparatuses. In this case, the interface between the operation apparatus and the electronic apparatuses as the control target apparatuses may be implemented using a network or a remote operation apparatus (so-called remote controller, such as an infrared ray remote controller). The remote controller may be used to control the target apparatuses from a distance. Preferably, the control part may be configured to control a plurality of control target apparatuses by means of a learning-type remote operation apparatus (learning remote controller). The learning-type remote operation apparatus is a remote operation apparatus that learns (i.e., stores) operation signals generated by multiple control target apparatuses so as to control these apparatuses alone. As such, the learning-type remote operation apparatus is also called a programmable remote controller. Alternatively, the remote controller may preset, in an internal storage device, signal information for operating a plurality of remote operation apparatuses. A single learning-type remote operation apparatus may be used to control all control target apparatuses configured.

### Specific Application Examples

Explained next are specific examples of the motion recognition apparatus, motion recognition method, operation apparatus, electronic apparatus, and program disclosed in this specification. The ensuing description will refer to an image sensing technique with no use of markers as the basic technique (sensing section) for recognizing the recognition target object. However, this is not limitative of the present disclosure. Alternatively, various sensors may be used as the sensing section.

### First Embodiment

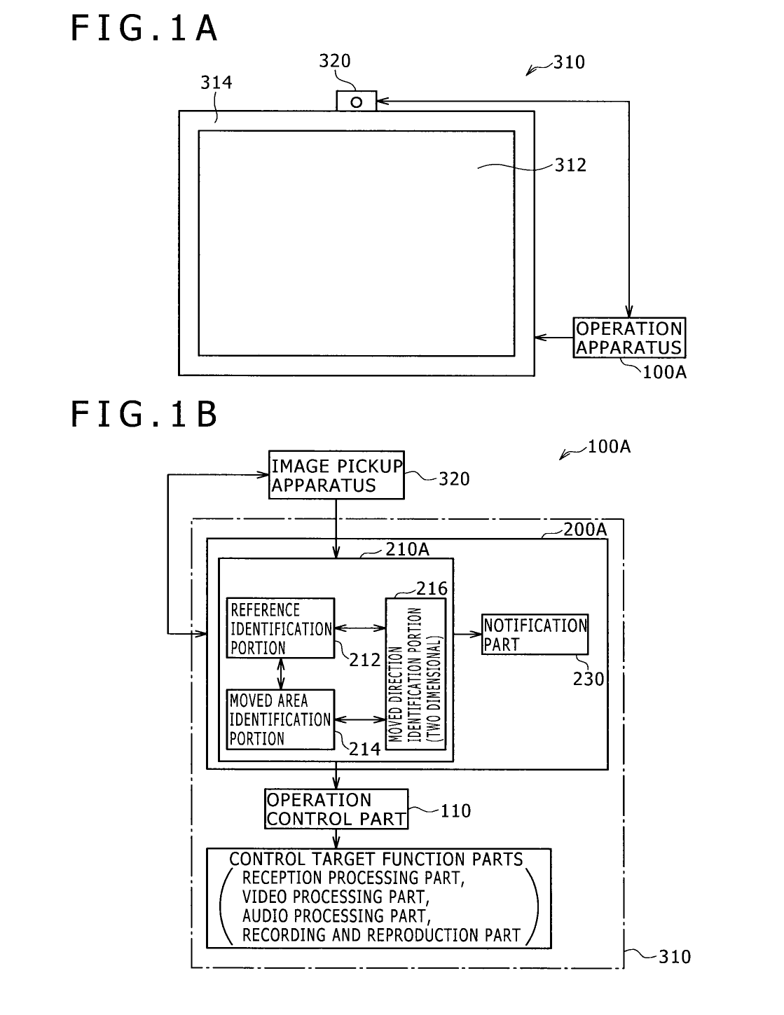

FIGS. 1A and 1B are explanatory views explaining a first embodiment of the present disclosure. More specifically, FIG. 1A is an outside view of an electronic apparatus in the first embodiment, and FIG. 1B is a functional block diagram of an operation apparatus in the first embodiment.

The first embodiment is a setup that recognizes images of the recognition target object in two-dimensional motion and uses the result of the recognition to operate the electronic apparatus (control target apparatus). The recognition target object may conceivably be the human hand or fingertip, for example.

As shown in FIG. 1A, the electronic apparatus of the first embodiment is specifically a TV set 310 equipped with a program recording function. In the first embodiment, the TV set 310 has a monocular image pickup apparatus 320 mounted on top of an external panel frame 314 of a display panel 312. Alternatively, the image pickup apparatus 320 may be built into the panel frame 314 itself, not mounted on top thereof.

As shown in FIG. 1B, an operation apparatus 100A of the first embodiment includes the image pickup apparatus 320, a motion recognition apparatus 200A, and an operation control part 110. The motion recognition apparatus 200A and operation control part 110 may be built into the TV set 310 as shown in FIG. 1B, or provided apart from the TV set 310 as indicated in FIG. 1A. In the illustrated example, there may be provided a reception processing part (a function part for changing channels), a video processing part for processing the video signal, an audio processing part for processing the audio signal, and a recording and reproduction part for recording and reproducing images as control target function parts making up a processing part that performs processes corresponding to the functions of the TV set 310.

The motion recognition apparatus 200A includes a motion recognition part 210A and a notification part 230. In some variations of the embodiment, the notification part 230 may be omitted. The image pickup apparatus 320 takes images that include the operator's hand and feeds the taken images to the motion recognition part 210A. The motion recognition part 210A recognizes the motion of the recognition target object from the input taken images, and outputs the result of the recognition to the operation control part 110 and notification part 230. Based on the result of the recognition input from the motion recognition part 210A, the operation control part 110 determines the content of control of the TV set 310 acting as the control target apparatus, and controls the latter (TV set 310) accordingly.

The notification part 230 notifies the operator by image or by voice of the information to be referenced when the operator gives instructions to the operation apparatus 100A, the information representing the state of the operation apparatus 100A being recognized and/or the state of the control target apparatus being controlled (i.e., operation state), for example. The display panel 312 may double as a display device for the notification part 230. Alternatively, the notification part 230 may utilize a dedicated display device apart from the display panel 312. As another alternative, at the same time that an image is displayed (or without image display), a sound may be produced to indicate the detection of an origin (to be discussed later) or the detection of a motion.

### [Motion Recognition Part]

The motion recognition part 210A includes a reference identification portion 212, a moved area identification portion 214, and a moved direction identification portion 216. The reference identification portion 212 determines whether the recognition target object (e.g., hand) belongs to the origin determination area. The moved area identification portion 214 determines whether the recognition target object (e.g., hand) belongs to a movement determination area. The moved direction identification portion 216 determines the direction of an upward, downward, leftward or rightward motion of the recognition target object (flip motion, also called the flip gesture hereunder) based on the results of the determinations made by the reference identification portion 212 and moved area identification portion 214. The moved direction identification portion 216 in the motion recognition part 210A recognizes one flip motion in the direction of the movement determination area recognized by the moved area identification portion 214 upon recognizing the recognition target object moving from the origin determination area to the movement determination area before moving back to the origin determination area.

When recognizing such a flip gesture, the motion recognition part 210A establishes partial areas of diverse sizes in various locations of an image taken, and slices up the image into the partial areas. For example, the partial areas may be established by providing as many as N window sizes, the window of each size being scanned for an image. The motion recognition part 210A normalizes input partial areas to predetermined sizes and scans the areas using textbook data preset in the storage part to see if there exists an object to be recognized.

The above-described technique is but one example of what may be implemented by the motion recognition part 210A. For example, there may also be used a method for evaluating the degree of similarity between a contour image generated from the input image on the one hand and reference images on the other hand, or a method for evaluating the degree of similarity in pattern between skin-color areas in the input image. If the method for skin-color area evaluation is adopted, skin-color-like areas may be extracted stably from the input image when color information is expressed using a uniformly perceived color space that matches the human visual property. It should be noted that where the uniformly perceived color space is utilized for color information expression, brightness under different illuminating conditions and other factors can pose a significant influence. To counter this bottleneck, the perceived color space may be processed using signals of the Ostwald color system such as the HSL space or HSV space, where the component H stands for hue, S for saturation, L for lightness, and V for value.

The operation control part 110 determines the content of control based on the flip gesture recognized by the motion recognition part 210A, and controls accordingly the TV set 310 acting as the control target apparatus. With this embodiment, the origin determination area of the hand (origin area) is first established, and determination areas are defined in directions over distances each exceeding a threshold value relative to the established origin determination area. A motion (gesture) in a given direction is recognized when the hand is moved from the origin determination area to the determination area in the direction of interest before returning to the origin determination area. This embodiment of object recognition will be discussed below in more detail.

### [Flip Gestures]

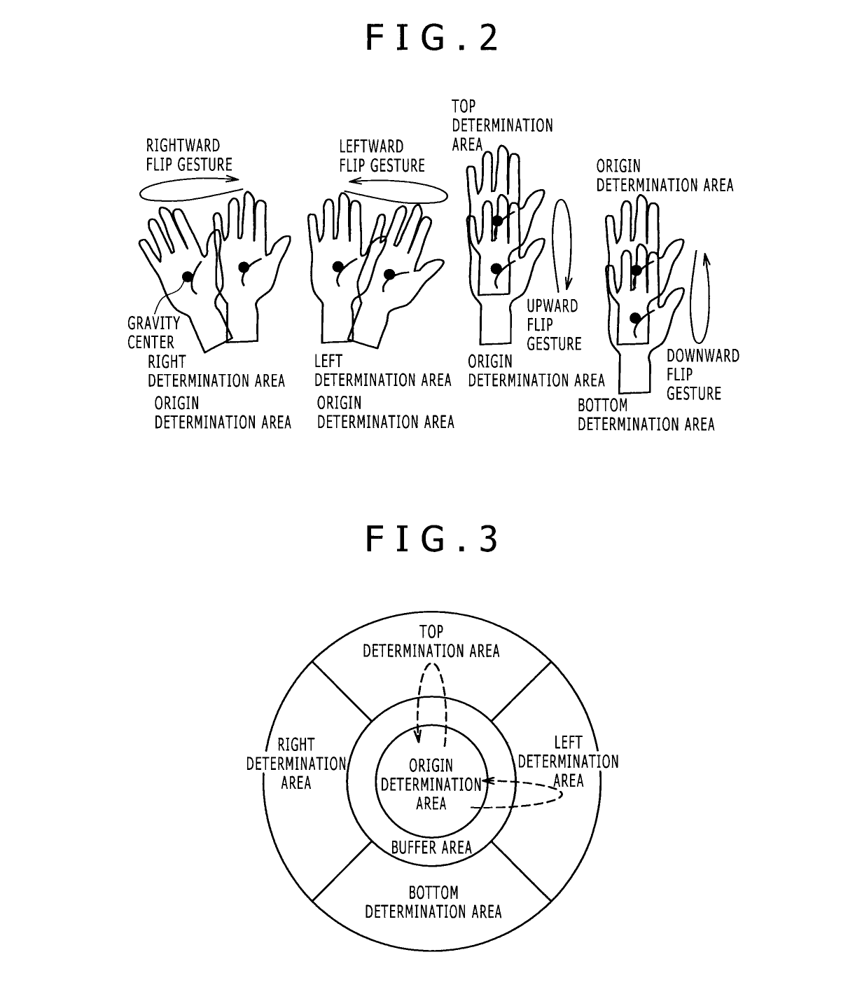

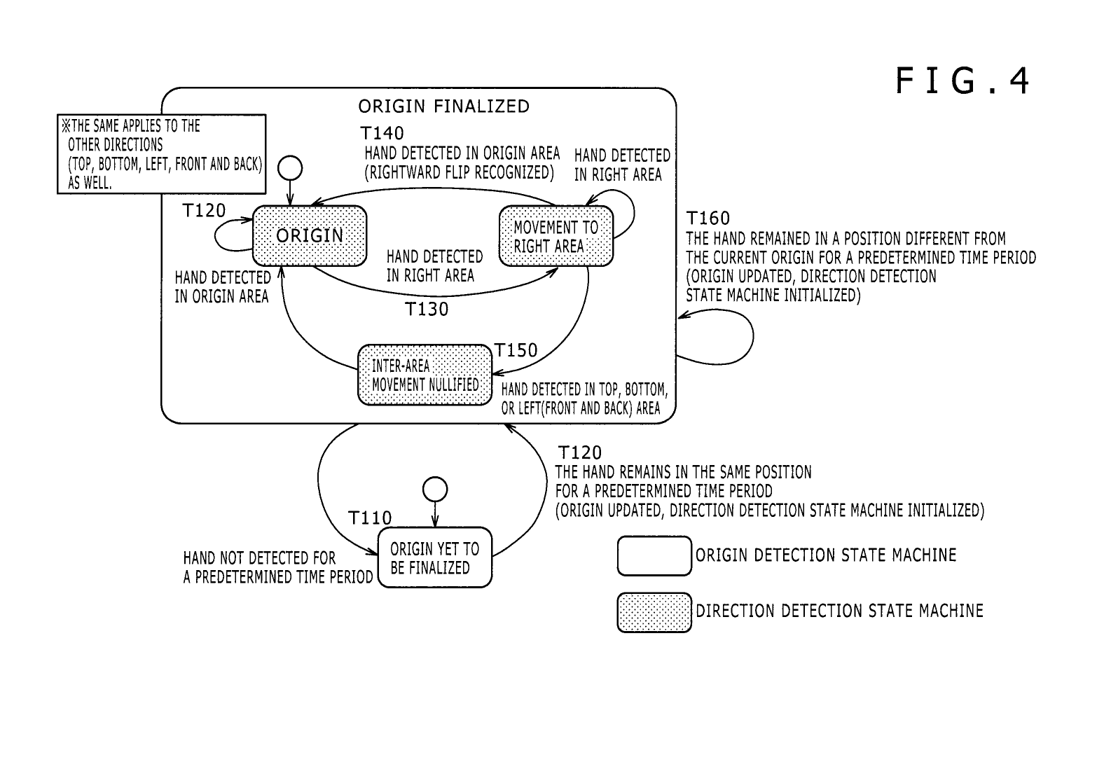

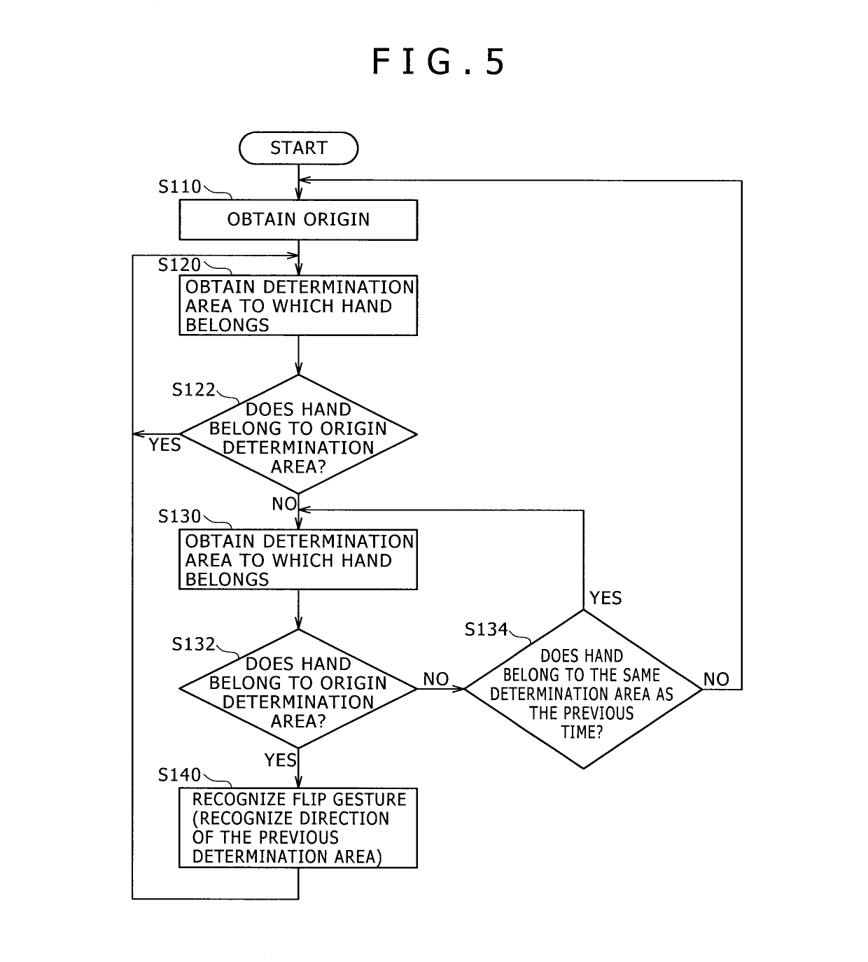

FIGS. 2 through 5 are explanatory views explaining operation control performed by the first embodiment. Specifically, FIG. 2 explains typical flip gestures. FIG. 3 explains typical areas for use in recognizing directions. FIG. 4 is a state transition diagram in effect when directions are recognized. FIG. 5 is a flowchart explaining a procedure carried out by the motion recognition part 210A in recognizing the directions.

As shown in FIG. 2, a flip gesture is a motion performed by the operator's hand being moved in a given direction before being moved back to its initial position. In this respect, the first embodiment recognizes conceptually a swing motion (one flip gesture indicating a direction) when the gravity center (i.e., center) coordinates of the hand move into one determination area before moving back to the initial position, as shown in FIG. 3, the movement being indicative of the direction in which exists one determination area relative to the origin determination area. When the recognition target object is recognized to move sequentially through a plurality of determination areas, the embodiment recognizes conceptually a swing motion which differs from any swing motion indicating a direction and which is predetermined corresponding to the sequence of the object movement.

First of all, it is assumed that the hand's area has been extracted from an image taken by the image pickup apparatus 320. According to the basic concept of motion recognition with this embodiment, the origin (gravity center) of the hand is first identified. When the hand is recognized to move from the origin determination area to a top, bottom, left or right determination area before moving back to the original determination area, the input of one flip gesture is recognized. In order to implement this kind of motion recognition, the motion recognition part 210A has two state transition machines: an origin detection state machine (corresponding to the reference identification portion 212) and a direction detection state machine (corresponding to the moved area identification portion 214 and moved direction identification portion 216), as shown in FIG. 4. The origin detection state machine continuously captures the hand position to see if the hand remains in a given position. The direction detection state machine monitors the origin and the direction in which the hand may move relative to that origin so as to detect the presence or absence of a flip gesture and the direction of that gesture.

The initial state is a state in which the origin has yet to be finalized (T110 in FIG. 4). When the operator's hand is held still in front of the image pickup apparatus 320 for a predetermined time period (e.g., one second), the origin detection state machine determines that the origin is finalized and transitions into an origin finalized state. At the same time, the direction detection state machine is initialized. The initial state of the direction detection state machine is an origin state (T120 in FIG. 4). That is, the motion recognition part 210A obtains the origin of the hand (S110 in FIG. 5). For example, the motion recognition part 210A obtains the gravity center (i.e., center) of the hand area and takes as the origin the position of the hand's gravity center in effect when the center has remained substantially still for a predetermined time period.

In that case, with an unintended shake of the operator's hand taken into account, the gravity center recognized to fall within a circular area with a predetermined radius for the predetermined time period is regarded as belonging to the origin determination area (shown in FIG. 3). A buffer area not recognizable as any area is established interposingly between the origin determination area on the one hand and the top, bottom, left and right determination areas on the other hand. Although not shown, a buffer area may also be provided between the top, bottom, left and right determination areas. This can prevent erroneous operations such as hand gestures getting recognized continuously if the operator's hand being located near the area boundaries shakes unintentionally. For example, the motion recognition part 210A may obtain the area to which the hand belongs (S120 in FIG. 5). If the hand is recognized to remain in the origin determination area, the motion recognition part 210A determines that there is no hand movement (“YES” in S122).

The direction detection state machine monitors the origin and the direction of the hand movement relative to the origin, and detects the presence or absence of a flip gesture and the direction of that gesture. At this time, upon recognizing the hand having moved out of one previously recognized determination area before moving back to the origin determination area without passing through any other determination area, the direction detection state machine recognizes the presence of one flip gesture. For example, upon recognizing the hand having moved out of the origin determination area (“NO” in S122 of FIG. 5), the motion recognition part 210A determines whether the hand belongs to any one of the top, bottom, left and right determination areas after moving over at least a threshold distance (i.e., beyond the buffer area) in any direction (S130 in FIG. 5). In this example, it is determined that the hand now belongs to the right determination area. If the hand is recognized to move out of the origin determination area before moving back to the origin determination area without moving through any of the top, bottom, left and right determination areas, it is determined that there has been no flip gesture, as explained above.

For example, if the operator's hand is moved to the right determination area shown in FIG. 3, the direction detection state machine transitions into a right determination area moved state (T130 in FIG. 4). If the operator again moves the hand to the origin determination area, the direction detection state machine returns to the origin state, and a rightward flip gesture is recognized (T140 in FIG. 4). For example, the motion recognition part 210A determines whether the hand moved out of the previously recognized right determination area over at least a threshold distance (i.e., beyond the buffer area) to move into the origin determination area (S132 in FIG. 5). If the hand is recognized to move out of the “previously recognized right determination area” before moving back to the origin determination area without passing through any other determination area, the motion recognition part 210A recognizes one flip gesture (rightward hand swing motion in this example; “YES” in S132, S140 in FIG. 5). If the hand is recognized to move out of the “previously recognized right determination area” before moving back to the previously recognized right determination area (“YES” in S134 in FIG. 5) without moving into the origin determination area (“NO” in S132 of FIG. 5), the motion recognition part 210A determines that a flip gesture has yet to be carried out. If the hand is recognized to move in an unexpected manner, e.g., the hand being moved to the right determination area before being moved into the top determination area, the direction detection state machine transitions into an inter-area movement nullified state (T150 in FIG. 4). When the hand is recognized to move back into the origin determination area, this state is canceled (“NO” in S134 in FIG. 5).

Conversely, if the hand is recognized to move leftward over at least the threshold distance (into the left determination area in FIG. 3) before moving back to the origin determination area, a leftward flip gesture is recognized. Similarly, if the hand is recognized to move upward over at least the threshold distance (into the top determination area in FIG. 3) before moving back to the origin determination area, an upward flip gesture is recognized. Conversely, if the hand is recognized to move downward over at least the threshold distance (into the bottom determination area in FIG. 3) before moving back to the origin determination area, a downward flip gesture is recognized. In any determination, the buffer area not belonging to any area may be provided between the origin determination area and the determination area in each direction as shown in FIG. 3. The presence of the buffer area prevents erroneous operations due to an unintended shake of the operator's hand.

The motion recognition part 210A also deals flexibly with cases in which the hand is moved in a totally unexpected manner. For example, the origin detection state machine operates continuously in parallel with the direction detection state machine. If the operator's hand is held still for a predetermined time period in a given area (a determination area or somewhere farther away from any determination area) different from the origin determination area, the origin (center position of the origin determination area) is set to the latest position of the hand's gravity center, and the direction detection state machine is initialized again (T160 in FIG. 4). In this manner, the operator can change the position of the origin determination area whenever desired and can perform flip gestures in any desired position within the range in which the hand is recognized.

### [Operation Control of the First Embodiment]

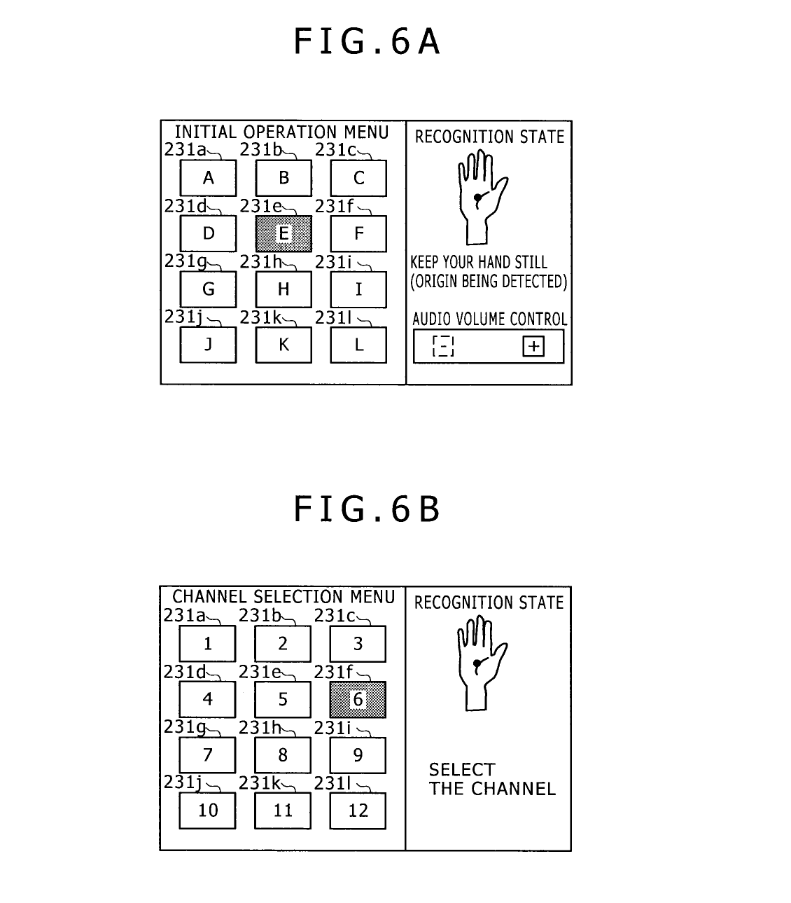

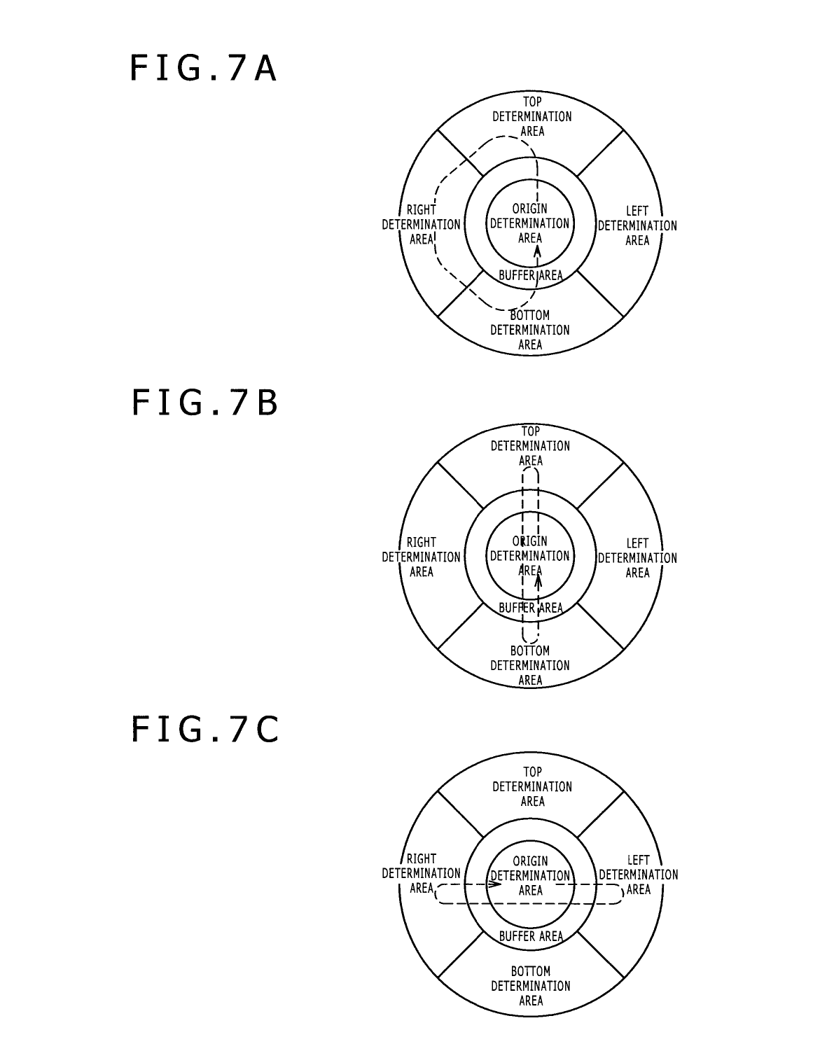

FIGS. 6A and 6B explain examples of control performed by the operation control part 110 of the first embodiment. FIGS. 7A, 7B and 7C explain a typical technique for identifying the finalize, back, and end instructions for menu operation with flip gestures.

For example, although not shown in the accompanying flowchart, the operator first performs a hand swing motion in order to communicate his or her operating intention. The motion recognition apparatus 200A “detects a hand swing motion” from an image taken by the image pickup apparatus 320 and picks up the operator from the image. It is also possible to use distance-measuring sensors such as infrared ray sensors in order to acquire three-dimensional position information, calculate the distance of the object from the image pickup apparatus 320 for zooming operations, and isolate candidate areas subject to gesture recognition processing. Thereafter, the hand area may be extracted from the color information about the hand swing position, for example. With the hand area thus extracted, the operation control part 110 displays operation screens such as those in FIGS. 6A and 6B, on the display panel 312 or the like.

The operation control part 110 determines the content of control based on the direction of the flip gesture recognized by the motion recognition part 210A, and controls the control target apparatus (TV set 310 in this example) accordingly. FIGS. 6A and 6B show typical menu screens displayed on the display panel 312. A recognition state area on these screens is used to notify the operator of the internal state of the operation control part 110. Each menu screen is made up of a plurality of rectangular areas 231 (distinguished from one another by reference characters a, b, etc.). The rectangular areas 231 are each associated with a specific command for operating the TV set 310.

As shown in FIG. 7A, when the hand is recognized to move back to the origin determination area after passing through a plurality of adjacent areas (e.g., three or more areas) among the top, bottom, left and right areas continuously in a relatively short time period, i.e., when the hand is recognized to draw an approximate circle in a relative short time, the motion recognition apparatus 200A determines that the finalize instruction for menu operation is issued. Also, as shown in FIG. 7B, when the hand is recognized to move from the origin determination area to the top determination area to the origin determination area to the bottom determination area to the origin determination area (or conversely, from the origin determination area to the bottom determination area to the origin determination area to the top determination area to the origin determination area) in a relatively short time period, i.e., when the hand is recognized approximately to move vertically in a short time, the motion recognition apparatus 200A determines that the back instruction is issued. Furthermore, as shown in FIG. 7C, when the hand is recognized to move from the origin determination area to the left determination area to the origin determination area to the right determination area to the origin determination area (or conversely, from the origin determination area to the right determination area to the origin determination area to the left determination area to the origin determination area) in a relative short time period, i.e., when the hand is recognized approximately to move horizontally in a short time, the motion recognition apparatus 200A determines that the end instruction is issued. When the hand is recognized to move from the origin determination area into any one of the top, bottom, left and right areas before moving back to the origin determination area and staying there for at least a predetermined time period, the motion recognition apparatus 200A recognizes the input of one flip gesture. In this manner, the input of one ordinary flip gesture indicative of a given direction is distinguished from the back instruction or end instruction. Depending on the operation screen in use, some or all of the finalize, back, and end instructions may not be needed.

For example, in FIG. 6A, a rectangular area 231e is displayed in a state different (shown hatched in the illustration) from that of the other rectangular areas. This means that the rectangular area 231e is currently selected. The “different state” may take many forms such as highlighting or the use of a color different from the other areas.

When the operator's hand is moved up, down, left or right relative to the image pickup apparatus 320 as shown in FIG. 2, the operation control part 110 changes the rectangular area selected on the menu screen in keeping with the hand movement. For example, in the state of FIG. 6A, if the operator's hand is moved from the origin determination area to the left determination area to the origin determination area before staying in the last area for at least a predetermined time period, the selected state of the rectangular area 231e is canceled, and the rectangular area 231d becomes a candidate for selection. This rectangular area 231d is displayed in a state different from that of the other rectangular areas. It should be noted that in this state, the operation menu has yet to be finalized. In order to finalize the operation menu assigned to the rectangular area 231d, the flip gesture corresponding to the finalize instruction is carried out as shown in FIG. 7A. The finalize instruction thus issued causes the operation control part 110 to execute the command (e.g., for channel changing operation or for the display of a recording reservation operation screen) associated with the finalized rectangular area (rectangular area 231d in this example).

On the other hand, if the rectangular area 231d becomes a candidate for selection because of the operator's erroneous operation or due to faulty recognition by the motion recognition part 210A, the operator carries out the flip gesture for the back instruction as shown in FIG. 7B. In this case, the operation control part 110 cancels the selected state of the rectangular area 231d, turns the initial rectangular area 231e again into a candidate for selection, and displays the rectangular area 231e in a state different from that of the other rectangular areas. Or if it is desired to end the operation instructions based on flip gestures, the operator performs the flip gesture for the end instruction as shown in FIG. 7C. In this case, the operation control part 110 turns off the operation screen shown in FIG. 6A.

When a channel changing operation screen is selected in response to the finalize instruction as illustrated in FIG. 6B, each rectangular area 231 on the operation screen of FIG. 6B is shown assigned to a channel number. In this case, the rectangular area 231 corresponding to the currently selected channel is displayed in a state different from that of the other rectangular areas. When another rectangular area 231 is selected by a flip gesture, the operation control part 110 switches to the channel assigned to the selected rectangular area 231 without waiting for a finalize instruction to be issued. For example, whereas channel 6 is shown selected in FIG. 6B, if channel 5 on the left is selected, the operation control part 110 immediately switches to channel 5. If this state is acceptable, the operator may carry out the flip gesture for the back instruction as shown in FIG. 7B or the flip gesture for the end instruction as indicated in FIG. 7C. If it is further desired to select a channel adjacent to channel 5 (i.e., channel 1, 2, 4, 7 or 8), the operator proceeds to carry out a flip gesture for channel selection.

### [Notification Part]

Upon issuing operation instructions using flip gestures, the operator may need to know whether the origin has been detected or whether a gesture has been recognized. Otherwise it may not be possible for the operator smoothly to issue operation instructions using flip gestures. To counter this potential bottleneck, the first embodiment includes the notification part 230 for the purpose. The notification part 230 notifies the operator of information as to whether the origin has been detected, whether gesture recognition has been successful, and other information in an easily understandable manner (see the recognition state area in FIGS. 6A and 6B). Depending on the type of electronic apparatus, the notification part 230 may cause the display panel 312 to display a message, a glowing point, and a blinking hand shape so as to, say, have the hand kept still when the origin is being detected. At this time, the notification part 230 may also cause the display panel 312 to display the hand's gravity center position identified by the operation apparatus 100A (specifically, by its reference identification portion 212). Once the detection of the origin is finalized, the glowing point and the blinking hand shape may be turned off (to return to normal display).

Where a given direction is to be detected, an icon may be displayed for operating the apparatus after a flip gesture is performed in that direction. For example, where the audio volume of the TV set 310 is to be operated, a “plus (+)” icon may be displayed on the right for turning up audio volume and a “minus (−)” icon on the left for turning down audio volume as the feedback to the operator. Furthermore, at the same time that display is made on the display panel 312, a sound may be produced when the origin is detected or when a flip gesture is recognized as the feedback to the operator.

### [Effects of the First Embodiment]

According to the first embodiment discussed above, it is possible to recognize flip gestures for use in operations thereby to control the control target apparatus in operation. This improves the ease of operation of the apparatus. There is no need for massive sample data and complicated learning processes that were deemed necessary for ordinary motion recognition. Also, there is no need for a memory that would accommodate the results of learning. Once flip gestures are recognized, it is possible to operate the applications on a contact type terminal which use flip gesture (for Internet browsing, book/newspaper reading, photo display, etc.) in non-contact fashion, which enhances the ease of use for the operator.

There may be further advantages of the non-contact operation capability. For example, when operating home appliances such as the TV set, users need not to operate the remote controller or search for it, which improves the usability of the appliance in question. As another example, where it is desired to operate the target apparatus (such as the air-conditioner, car navigation system, etc.) from a remote location (such as from the backseat of a passenger car), or where it is difficult directly to operate the apparatus (e.g., medical equipment) because of soiled hands, the non-contact operation capability allows the apparatus to be operated from a distance. As a further example, video game machines and digital signage stations may be operated in non-contact fashion as a novel form of entertainment. In such cases, the scope of operability of the games and signage stations can be expanded because there is no need for controllers.

In recognizing flip gestures, the first embodiment need only recognize the approximate state of motions of the recognition target object (e.g., the movement of the hand's gravity center position is utilized in the preceding examples). With no need to recognize the detailed shape of the hand or its changing state, the embodiment can be implemented with a device configuration excluding numerous high-speed computing resources.

### Second Embodiment

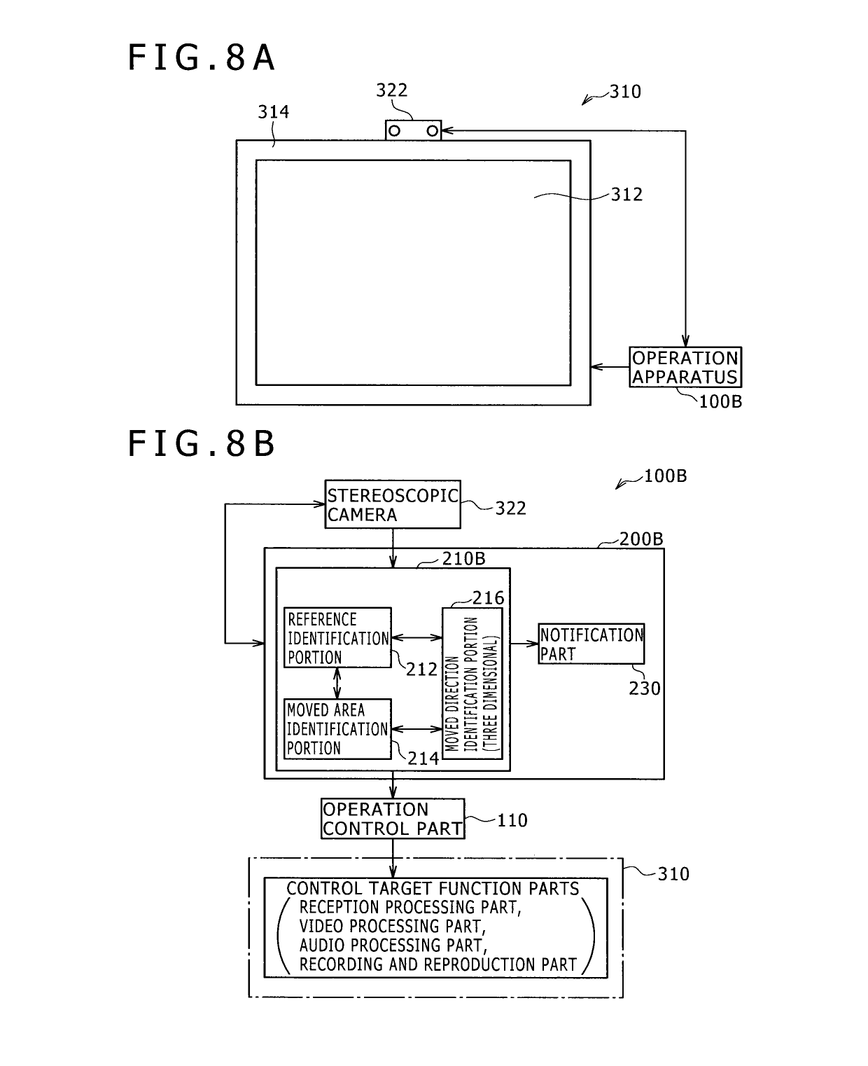

FIGS. 8A and 8B explain a second embodiment of the present disclosure. FIG. 8A is an outside view of an electronic apparatus in the second embodiment, and FIG. 8B is a block diagram of an operation apparatus in the second embodiment.

The second embodiment involves performing image recognition of the recognition target object in three-dimensional motion and utilizing the result of the recognition for operating the target electronic apparatus (control target apparatus).

Specifically, the electronic apparatus in the second embodiment is also a TV set 310 as shown in FIG. 8A. The second embodiment is different from the first embodiment in that a binocular image pickup apparatus (stereoscopic camera 322) is mounted on top of the panel frame to recognize three-dimensional motions using images. The stereoscopic camera 322 is used not only as the image pickup apparatus but also as a distance-measuring sensor for recognizing three-dimensional motions using images. However, the distance-measuring sensor is not limited to stereoscopic cameras. Alternatively, other distance-measuring sensors such as infrared ray sensors may be used to detect three-dimensional motions.

As shown in FIG. 8B, an operation apparatus 100B in the second embodiment 2 includes the stereoscopic camera 322, a motion recognition apparatus 200B, and an operation control part 110. The motion recognition apparatus 200B and operation control part 110 may be built in the TV set 310 or may be provided apart from the TV set 310 as illustrated. The motion recognition apparatus 200B includes a motion recognition part 210B and a notification part 230. The notification part 230 may be omitted depending on the variation of the embodiment.

The motion recognition part 210B of the second embodiment is different from the motion recognition part 210A of the first embodiment in that the moved direction identification portion 216 recognizes three-dimensional flip gestures. The basic idea is that the motion recognition part 210B can recognize the recognition target object also in front-back motion. The recognition of flip gestures by the motion recognition part 210B is the same in nature as the recognition of the motion of the target object in any of the top, bottom, left and right directions.

Generally, in stereoscopic applications, the correspondence relation between a plurality of cameras is obtained and a three-dimensional position is acquired from two-dimensional images taken by the cameras. For example, a plurality of monocular cameras may conceivably be set up in an appropriate relation to each other for position recognition. However, where there is a long distance between the cameras, it is difficult to obtain the exact correspondence relation therebetween; hence a growing error in the recognition. In view of this, the second embodiment uses not monocular cameras but the stereoscopic camera 322 to take stereoscopic images that permit recognition of the three-dimensional position of the recognition target object.

The operator thus performs a hand swing motion in order to communicate his or her operating intention. The motion recognition part 210B detects the “hand swing motion” from an image taken by the stereoscopic camera 322 and obtains the three-dimensional position of the hand swing motion through stereoscopic measurements. Based on this position information, the stereoscopic camera 322 is caused to pan, tilt and/or zoom to closely observe the areas in which gesture recognition processing is carried out. Upon detection of the hand swing motion, the zoom setting should preferably be on the wide-angle side so that hand swing motions may be detected in an extensive range inside the room. Then the hand area is extracted using the color information about the hand swing position, for example. Furthermore, the direction of the flip gesture is recognized. The operation control part 110 determines the content of control based on the direction of the flip gesture recognized by the motion recognition part 210B, and controls the control target apparatus (TV set 310 in this example) accordingly.

### [Operation Control of the Second Embodiment]

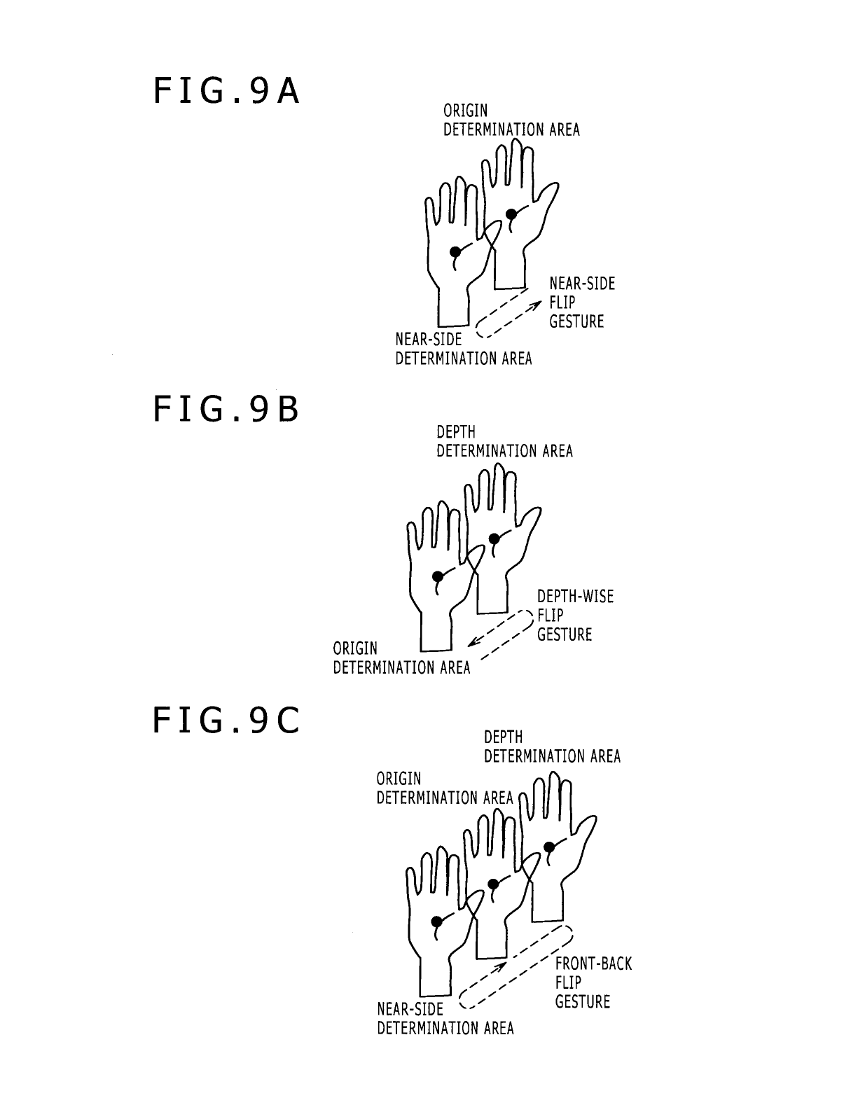

FIGS. 9A, 9B and 9C explain a typical technique for identifying the finalize, back, and end instructions for menu operation by the second embodiment with flip gestures. The second embodiment performs image recognition of the recognition target object in three-dimensional motion, assigning the front-back motion of the hand to the finalize, back, and end instructions. The other embodiments of the functionality of the second embodiment are the same as those of the first embodiment.

For example, as shown in FIG. 9A, the motion recognition apparatus 200B may recognize the hand moving away from the body into the near-side determination area before moving back to the origin determination area and staying there for at least a predetermined time period. In such a case, the motion recognition apparatus 200B determines that one flip gesture corresponding to the finalize instruction for menu operation has been input. Also, as shown in FIG. 9B, the motion recognition apparatus 200B may recognize the hand drawn toward the body and moving into the depth determination area before moving back to the origin determination area and staying there for at least a predetermined time period. In that case, the motion recognition apparatus 200B determines that one flip gesture corresponding to the back instruction has been input. Furthermore, as shown in FIG. 9C, the motion recognition apparatus 200B may recognize the hand moving from the origin determination area to the depth determination area to the origin determination area to the near-side determination area to the origin determination area (or conversely, from the origin determination area to the near-side determination area to the origin determination area to the depth determination area to the origin determination area) in a relatively short time period. That is, the motion recognition apparatus 200B may recognize the hand moving approximately in the front-back direction in a short time. In this case, the motion recognition apparatus 200B determines that the end instruction has been issued. In this manner, it is possible to make the distinction among the input of one flip gesture corresponding to the finalize instruction, the input of another flip gesture corresponding to the back instruction, and the end instruction.

In the above case, too, with an unintended shake of the operator's hand taken into account, the gravity center of the hand recognized to stay within a predetermined range (origin determination area in FIGS. 9A through 9C) for a predetermined time period is regarded as the origin. A buffer area not recognizable as any area may also be established interposingly between the origin determination area on the one hand and the front and back areas (depth determination area and near-side determination area) on the other hand. This can prevent erroneous operations such as hand gestures getting recognized continuously if the operator's hand being located near the area boundaries in the front-back direction of the determination area shakes unintentionally.

### [Effects of the Second Embodiment]

The finalize instruction is identified on the basis of the hand being recognized to move into the near-side determination area. This turns out to be approximately the same operation as pressing a button on a physical remote controller. The operator can thus issue the finalize instruction feeling as if actually operating the remote controller.

### [Variation of the Second Embodiment]

In the foregoing description, the finalize, back, and end instructions were shown identified on the basis of the hand being recognized to move in the front-back direction. Alternatively, the rectangular areas 231 may be deployed three-dimensionally, each three-dimensionally established rectangular area 231 being assigned a given command.

### Third Embodiment

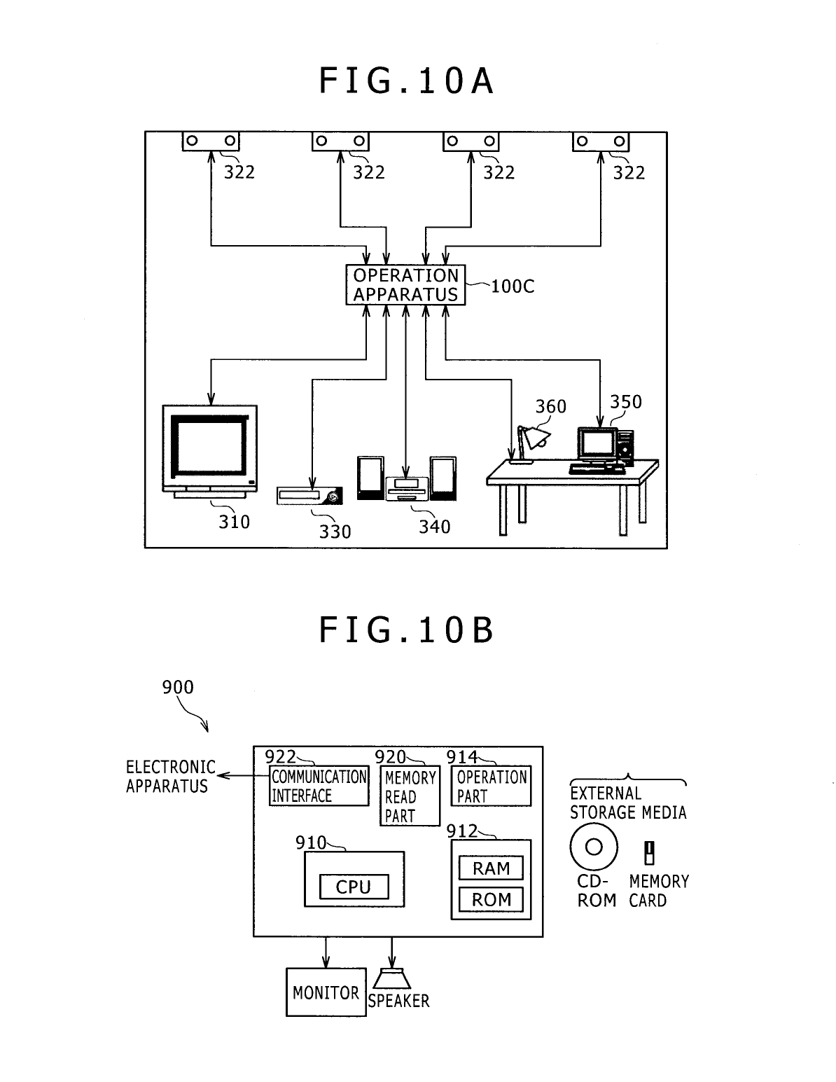

FIGS. 10A and 10B explain a third embodiment of the present disclosure. FIG. 10A is a schematic view showing an overall configuration of the third embodiment. FIG. 10B is a functional block diagram of an operation apparatus in the third embodiment.

The third embodiment has a plurality of electronic apparatuses (control target apparatuses) made controllable. The third embodiment is different from a fourth embodiment, to be discussed later, in that an operation apparatus 100C of the third embodiment is configured to control electronic apparatuses 1 over a wired or wireless network. Incidentally, the recognition target object in motion may be recognized either two-dimensionally as with the first embodiment, or three-dimensionally as with the second embodiment. The ensuing paragraphs will explain how three-dimensional motions of the recognition target object are recognized using images as with the second embodiment.

Actual applications of the third embodiment typically envisage carrying out the operations of information equipment in the office as well as information-based household appliances (e.g., personal computer (PC), TV set, DVD player, Blu-ray player, and other AV (Audio and Visual) equipment).

As shown in FIG. 10A, there may exist in the room a TV set 310, a video recording and reproducing apparatus 330, audio equipment 340, a PC 350, and a light fixture 360 as electronic apparatuses constituting the control target apparatuses. The operation apparatus 100C is connected to the electronic apparatuses (TV set 310, PC 350, video recording and reproducing apparatus 330, and light fixture 360) via a network (wired or wireless).

A plurality of stereoscopic cameras 322 each having a pan-tilt-zoom function are set up where appropriate (e.g., near the ceiling) to monitor the room interior in order to perform image recognition of the recognition target object in three-dimensional motion. Alternatively, the stereoscopic cameras 322 may be replaced with image pickup apparatuses 320 for taking stereoscopic images. Generally, stereoscopic imaging involves obtaining the correspondence relation between a plurality of image pickup apparatuses and acquiring a three-dimensional position of the target object from two-dimensional images based on the obtained correspondence relation. For example, a plurality of monocular image pickup apparatuses may be attached to the ceiling of the room to perform position recognition. If there is a long distance between the image pickup apparatuses, it is difficult to obtain the exact correspondence relation therebetween, which can lead to a growing error in measurements. To circumvent this bottleneck, the third embodiment utilizes a plurality of binocular image pickup apparatuses (i.e., stereoscopic cameras 322), not the monocular image pickup apparatuses 320.

[Configuration with a Computer]

The operation apparatus 100C of the third embodiment is configured with a computer having a CPU, a RAM (Random Access Memory), a ROM (Read Only Memory), etc., for implementing by software the functionality of the operation apparatus 100B of the second embodiment. That is, the technique for controlling the electronic apparatus in operation is not limited to the use of hardware processing circuits; the technique may also be implemented with a computer running on software containing the program codes for bringing about the function. For this reason, a program as software executed by a computer to implement the technology of the third embodiment, or a computer-readable storage medium carrying that program, may be provided as another embodiment of the present disclosure. The use of software means that the procedures involved may be altered easily without requiring hardware modifications.

As shown in FIG. 10B, a computer system 900 making up the operation apparatus 100C that constitutes a control feature for processing the operations of the electronic apparatuses includes: a central control part 910 composed of a CPU or a microprocessor; a storage part 912 including a ROM for read-only operations or a RAM for random read and write operations; an operation part 914; and other peripheral members, not shown. The computer system 900 is connected to a monitor and speakers so that the operator may be notified by image or by voice the information to be referenced when operating the electronic apparatuses.

The central control part 910 is substantially the same as the core of the computer typified by the CPU that places computer-based calculation and control functions into a miniature integrated circuit. The ROM stores the control program and other resources for processing the operations of the electronic apparatuses. The operation part 914 is a user interface that accepts operations made by users.

A control section of the computer system 900 may be configured to have an external recording medium (not shown) such as a memory card attached removably so as to establish connection with a communication network such as the Internet. The configuration of the control section may include, in addition to the central control part 910 and storage part 912, a memory read part 920 for reading information from the portable recording medium and a communication interface 922 for interfacing with external entities. The memory read part 920, when provided, can have programs installed or updated from the external recording medium. The communication interface 922, when attached, can get programs installed or updated via the communication network. With the third embodiment, the communication interface 922 is also used to transmit control signals from the operation apparatus 100C to the electronic apparatuses configured (TV set 310, PC 350, video recording and reproducing apparatus 330, and light fixture 360). The basic method for processing the operations of the electronic apparatuses is the same as with the second embodiment.

Incidentally, the programs with which the computer system 900 controls the operations of the electronic apparatuses may be the same as those incorporated in the remote controllers of these apparatuses, for example. This makes it possible to implement the same remote controller functions as those for operating the target electronic apparatus.

The programs may be offered recorded on a computer-readable recording medium (e.g., semiconductor memory, magnetic disk, or optical disk), or distributed via a wired or wireless communication section. For example, the programs for causing the computer to execute the function of controlling the operations of the electronic apparatuses may be offered or distributed using a portable recording medium. For example, the programs may be offered or distributed on a CD-ROM (Compact Disc Read Only Memory) or FD (Flexible Disk). It is also possible to set up an MO (Magneto-optical Disk) drive for recording the programs on an MO. The programs may be further offered or distributed recorded on other recording media including card type storage media utilizing nonvolatile semiconductor memories such as flash memories. The programs making up software is not limited to being offered or distributed using recording media; the programs may also be offered or distributed via a communication section (wired or wireless). For example, the programs may be downloaded or updated from servers over networks such as the Internet. The programs are offered in the form of a file that describes program codes for implementing the function of controlling the operations of the electronic apparatuses. In this case, the programs are not limited to being offered in a single program file; the programs may also be offered in the form of discrete program modules depending on the system hardware configuration of the computer in use.

The foregoing paragraphs explained how the control feature for processing the operations of the electronic apparatuses is specifically implemented using software executed on a computer. However, it is obvious to those skilled in the art that the components (including functional blocks) of the control feature for processing the electronic apparatus operations may be specifically implemented using hardware, software, communication section, a combination of them, or some other suitable units. As another alternative, some functional blocks may be combined to form a single functional block. Also, the software for causing the computer to execute program processing may be installed in distributed fashion depending on the combination of the configured mode.

[Operation Control]

In the setup shown in FIG. 10A, the zoom setting of the stereoscopic cameras 322 is on the wide-angle side. In a suitable location in the room (preferably near the monitor), the operator performs a hand gesture to communicate his or her intention of operating a given electronic apparatus. When the stereoscopic cameras 322 detect the hand gesture, the operation apparatus 100C (computer system 900; ditto hereunder) obtains the three-dimensional position of the hand gesture through stereoscopic measurements. Based on the position information thus obtained, the operation apparatus 100C causes the stereoscopic cameras 322 to pan, tilt, and zoom to closely observe the areas in which gesture recognition processing is carried out. While verifying the monitor screen, the operator proceeds to perform flip gestures giving instructions to select and operate the target electronic apparatus. At this point, the operation apparatus 100C finalizes the selection of the target electronic apparatus and the content of control thereof based on the directions of the recognized flip gestures, and controls the control target apparatus (i.e., selected electronic apparatus in this example) accordingly. The result of the recognition can be verified by display on the monitor and by sound from the speakers.

### Fourth Embodiment

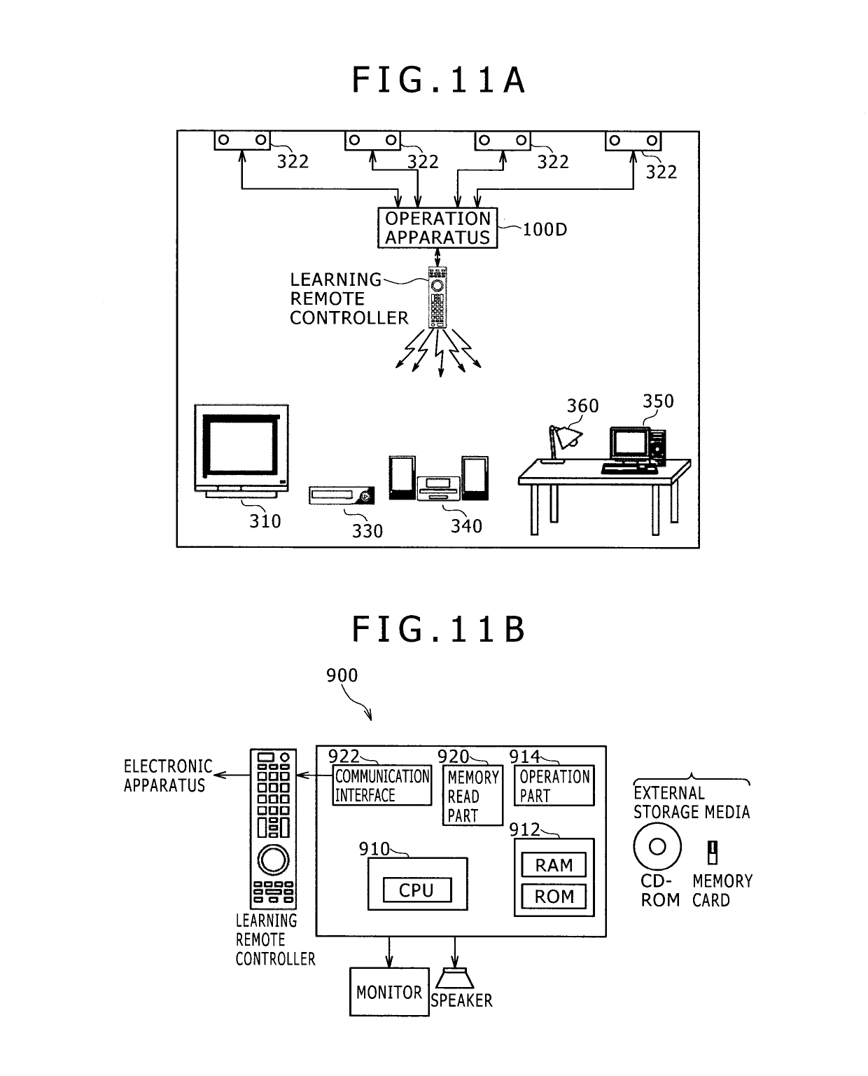

FIGS. 11A and 11B explain a fourth embodiment of the present disclosure. FIG. 11A is a schematic view showing an overall configuration of the fourth embodiment.

FIG. 11B is a functional block diagram of an operation apparatus in the fourth embodiment.

The fourth embodiment has a plurality of electronic apparatuses (control target apparatuses) made controllable. The fourth embodiment is different from the third embodiment in that an operation apparatus 100D of the fourth embodiment is configured to control the electronic apparatuses 1 using a learning remote controller (learning type infrared ray remote controller). That is, the control signals from the operation apparatus 100D are transmitted to the electronic apparatuses (TV set 310, PC 350, video recording and reproducing apparatus 330, light fixture 360) using a learning remote controller connected to the computer system 900. When the learning remote controller is used, one program for the remote controller need only be installed in the computer system 900. By contrast, the third embodiment discussed above involves having individual programs installed therein for controlling the operations of all electronic apparatuses targeted for control. Even if a remote controller(s) were utilized, individual programs for the remote controllers of the electronic apparatuses would need to be installed in the third embodiment.

Although the technology disclosed in this specification has been described above using specific embodiments, the technical scope of what is described in the appended claims is not limited by the descriptions of the embodiments. The embodiments explained above may be modified, altered, or improved in diverse fashion within the scope and spirit of the technology disclosed in this specification. It is to be understood that such modifications, alterations, and improvements fall within the technical scope of the disclosed technology. The above-described embodiments do not limit the techniques depicted in the appended claims, and not all combinations of the features of the disclosed technology explained in conjunction with the embodiments are indispensable to the means for solving the problems addressed by the technology disclosed in this specification. The embodiments discussed above include various stages of the disclosed technology, from which it is possible to extract various techniques using a suitable combination of a plurality of configured requirements disclosed herein. Even if some of all configured requirements described in connection with the embodiments are omitted, the configuration minus the omitted requirements may also be extracted as one of the techniques disclosed in this specification as long as the disclosed technology offers the effects addressing the targeted problem.

For example, in the foregoing paragraphs, the hand as an example of the recognition target object in motion was shown recognized using only the gravity center (i.e., center) coordinates of the hand. Obviously, something other than the hand may be recognized instead. Although the image sensing technique without recourse to markers was explained to be used, the same algorithm may be utilized to recognize as flip gestures the operations of, say, swinging a marker-equipped pole. This embodiment of the technology is considered useful because it can expand the range of operation methods available for the operator to choose from.

Today, some operation techniques utilizing gesture recognition are proposed whereby the motions of the human (e.g., entire body, head, hands, fingertips, etc.) are recognized so that the result of the recognition is used to operate electronic apparatuses such as TV sets and computers. These techniques are also attracting attention as useful for operating robots. For example, the kinetic momentum generated when the hand is swung up and down, left and right, front and back, or in circles is measured by an image sensing technique or by sensors, and the measurement information is used as operation information. For example, gesture recognition involves recognizing the motion of the recognition target object (dynamic gestures) and the shape of that object (static gestures). Recognizing dynamic gestures may be implemented in one of three forms: using an image sensing technique for recognizing the displacements of the recognition target object in motion (not only overall displacements but also opened and closed finger displacements), its velocity, and its acceleration using a non-contact image pickup apparatus (camera); measuring the operator's recognition target object in motion using various sensors including the velocity sensor, acceleration sensor, and flexion angle sensor; or a combination of these two forms. In some cases where the image sensing technique is used, markers may be utilized to facilitate identification of the recognition target object. The recognition of static gestures involves recognizing the motions specific to the recognition target object. For example, if the recognition target object is the hand, the hand's shape and finger directions resulting from the opening and closing of the hand, a show of more or fewer fingers of the hand, and a varying finger opening angle of the hand may be detected as still pictures, with the tilt of the hand detected as a component of gravitational acceleration. Where the technology proposed in this specification is applied to these diverse cases, it is possible to simplify the computing processes carried out ordinarily to recognize the recognition target object in motion, and to dispense with numerous computing resources.

In view of the foregoing description of the embodiments of the present disclosure, the techniques claimed in the appended claims exemplify the disclosed technology. The following techniques may be extracted as such examples from the disclosure:

[Additional Statement 1]

A motion recognition apparatus including a motion recognition part configured such that upon recognizing a recognition target object moving from one determination area to one other determination area before moving back to the one determination area, the motion recognition part recognizes a predetermined swing motion.

### [Additional Statement 2]

The motion recognition apparatus described in additional statement 1 above, wherein, upon recognizing the recognition target object moving from an origin determination area to one determination area before moving back to the origin determination area without passing through any other determination area, the motion recognition part recognizes a swing motion indicative of the direction in which the one determination area exists relative to the origin determination area.

### [Additional Statement 3]

The motion recognition apparatus described in additional statement 1 or 2 above, wherein, upon recognizing the recognition target object moving sequentially through a plurality of determination areas, the motion recognition part recognizes a predetermined swing motion which differs from the swing motion indicative of any direction and which corresponds to the sequence of the object movement.

### [Additional Statement 4]

The motion recognition apparatus described in any one of additional statements 1 through 3 above, wherein, upon recognizing the recognition target object moving from an origin determination area to one determination area and then passing through an unexpected area before moving back to the origin determination area, the motion recognition part recognizes an inter-area movement nullified state.

### [Additional Statement 5]

The motion recognition apparatus described in additional statement 4 above, wherein, upon recognizing the recognition target object moving back to the origin determination area after recognizing the inter-area movement nullified state, the motion recognition part cancels the inter-area movement nullified state.

### [Additional Statement 6]

The motion recognition apparatus described in any one of additional statements 1 through 5 above, wherein, upon recognizing the recognition target object moving from an origin determination area to one other area and staying in the other area for at least a predetermined time period, the motion recognition part sets the other area as a new origin determination area.

### [Additional Statement 7]

The motion recognition apparatus described in any one of additional statements 1 through 6 above, wherein a buffer area not recognizable as any area is provided between the determination areas.

### [Additional Statement 8]

The motion recognition apparatus described in any one of additional statements 1 through 7 above, wherein the motion recognition part performs the process of recognizing the recognition target object in motion based on an image taken of the recognition target object.

### [Additional Statement 9]

The motion recognition apparatus described in additional statement 8 above, wherein the motion recognition part performs the process of recognizing the recognition target object in three-dimensional motion based on a stereoscopic image taken of the recognition target object.

### [Additional Statement 10]

The motion recognition apparatus described in any one of additional statements 1 through 9 above, further including a notification part configured to give notification of the state recognized by the motion recognition part.

### [Additional Statement 11]

A motion recognition method including: recognizing a recognition target object moving from one determination area to one other determination area before moving back to the one determination area; and using the result of the recognition in controlling a control target apparatus.

### [Additional Statement 12]

An operation apparatus including: a motion recognition part configured such that upon recognizing a recognition target object moving from one determination area to one other determination area before moving back to the one determination area, the motion recognition part recognizes a predetermined swing motion; and a control part configured to control a control target apparatus based on the result of the recognition by the motion recognition part.

### [Additional Statement 13]

The operation apparatus described in additional statement 12 above, wherein, upon recognizing the recognition target object moving sequentially through a plurality of determination areas, the motion recognition part recognizes a predetermined swing motion corresponding to the sequence of the object movement, and the control part instructs the control target apparatus to perform a predetermined operation corresponding to the swing motion recognized by the motion recognition part.

### [Additional Statement 14]

The operation apparatus described in additional statement 12 or 13 above, further including an image pickup apparatus configured to take an image of the recognition target object, wherein the motion recognition part performs the process of recognizing the recognition target object in motion based on the image taken of the recognition target object by the image pickup apparatus.

### [Additional Statement 15]

The operation apparatus described in additional statement 14 above, wherein the image pickup apparatus is configured to have a fly-eye lens arrangement for taking a stereoscopic image, and the motion recognition part performs the process of recognizing the recognition target object in three-dimensional motion based on the stereoscopic image taken of the recognition target object.

### [Additional Statement 16]

The operation apparatus described in any one of additional statements 12 through 15, further including a notification part configured to give notification of the state recognized by the motion recognition part and/or the state of the control target apparatus controlled by the control part.

### [Additional Statement 17]

The operation apparatus described in any one of additional statements 12 through 16 above, wherein the control part is configured to control a plurality of control target apparatuses.

### [Additional Statement 18]

The operation apparatus described in additional statement 17 above, wherein the control part is configured to control the plurality of control target apparatuses via a learning-type remote operation apparatus.

### [Additional Statement 19]

An electronic apparatus including: a processing part configured to perform processes corresponding to apparatus functions; a motion recognition part configured such that upon recognizing a recognition target object moving from one determination area to one other determination area before moving back to the one determination area, the motion recognition part recognizes a predetermined swing motion; and a control part configured to control the processing part based on the result of the recognition by the motion recognition part.

### [Additional Statement 20]

A program for causing a computer to function as an apparatus including: a motion recognition part configured such that upon recognizing a recognition target object moving from one determination area to one other determination area before moving back to the one determination area, the motion recognition part recognizes a predetermined swing motion; and a control part configured to control a control target apparatus based on the result of the recognition by the motion recognition part.

The present disclosure contains subject matter related to that disclosed in Japanese Priority Patent Application JP 2011-208947 filed in the Japan Patent Office on Sep. 26, 2011, the entire content of which is hereby incorporated by reference.

What is claimed is:

1. A motion recognition apparatus comprising
a motion recognition part configured such that upon recognizing a recognition target object moving from one determination area to one other determination area before moving back to said one determination area, said motion recognition part recognizes a predetermined swing motion.

2. The motion recognition apparatus according to claim 1, wherein, upon recognizing said recognition target object moving from an origin determination area to one determination area before moving back to said origin determination area without passing through any other determination area, said motion recognition part recognizes a swing motion indicative of the direction in which said one determination area exists relative to said origin determination area.

3. The motion recognition apparatus according to claim 1, wherein, upon recognizing said recognition target object moving sequentially through a plurality of determination areas, said motion recognition part recognizes a predetermined swing motion which differs from the swing motion indicative of any direction and which corresponds to the sequence of the object movement.

4. The motion recognition apparatus according to claim 1, wherein, upon recognizing said recognition target object moving from an origin determination area to one determination area and then passing through an unexpected area before moving back to said origin determination area, said motion recognition part recognizes an inter-area movement nullified state.

5. The motion recognition apparatus according to claim 4, wherein, upon recognizing said recognition target object moving back to said origin determination area after recognizing said inter-area movement nullified state, said motion recognition part cancels said inter-area movement nullified state.

6. The motion recognition apparatus according to claim 1, wherein, upon recognizing said recognition target object moving from an origin determination area to one other area and staying in said other area for at least a predetermined time period, said motion recognition part sets said other area as a new origin determination area.

7. The motion recognition apparatus according to claim 1, wherein a buffer area not recognizable as any area is provided between the determination areas.

8. The motion recognition apparatus according to claim 1, wherein said motion recognition part performs the process of recognizing said recognition target object in motion based on an image taken of said recognition target object.

9. The motion recognition apparatus according to claim 8, wherein said motion recognition part performs the process of recognizing said recognition target object in three-dimensional motion based on a stereoscopic image taken of said recognition target object.

10. The motion recognition apparatus according to claim 1, further comprising
a notification part configured to give notification of the state recognized by said motion recognition part.

11. A motion recognition method comprising:
recognizing a recognition target object moving from one determination area to one other determination area before moving back to said one determination area; and
using the result of the recognition in controlling a control target apparatus.

12. An operation apparatus comprising:
a motion recognition part configured such that upon recognizing a recognition target object moving from one determination area to one other determination area before moving back to said one determination area, said motion recognition part recognizes a predetermined swing motion; and
a control part configured to control a control target apparatus based on the result of the recognition by said motion recognition part.

13. The operation apparatus according to claim 12,
wherein, upon recognizing said recognition target object moving sequentially through a plurality of determination areas, said motion recognition part recognizes a predetermined swing motion corresponding to the sequence of the object movement, and
said control part instructs said control target apparatus to perform a predetermined operation corresponding to the swing motion recognized by said motion recognition part.

14. The operation apparatus according to claim 12, further comprising
an image pickup apparatus configured to take an image of said recognition target object,
wherein said motion recognition part performs the process of recognizing said recognition target object in motion based on the image taken of said recognition target object by said image pickup apparatus.

15. The operation apparatus according to claim 14,
wherein said image pickup apparatus is configured to have a fly-eye lens arrangement for taking a stereoscopic image, and
said motion recognition part performs the process of recognizing said recognition target object in three-dimensional motion based on the stereoscopic image taken of said recognition target object.

16. The operation apparatus according to claim 12, further comprising
a notification part configured to give notification of the state recognized by said motion recognition part and/or the state of said control target apparatus controlled by said control part.

17. The operation apparatus according to claim 12, wherein said control part is configured to control a plurality of control target apparatuses.

18. The operation apparatus according to claim 17, wherein said control part is configured to control said plurality of control target apparatuses via a learning-type remote operation apparatus.

19. An electronic apparatus comprising:
a processing part configured to perform processes corresponding to apparatus functions;
a motion recognition part configured such that upon recognizing a recognition target object moving from one determination area to one other determination area before moving back to said one determination area, said motion recognition part recognizes a predetermined swing motion; and
a control part configured to control said processing part based on the result of the recognition by said motion recognition part.

20. A program for causing a computer to function as an apparatus comprising:
a motion recognition part configured such that upon recognizing a recognition target object moving from one determination area to one other determination area before moving back to said one determination area, said motion recognition part recognizes a predetermined swing motion; and
a control part configured to control a control target apparatus based on the result of the recognition by said motion recognition part.
